(19) United States
(12) Patent Application Publication
(10) Pub. No.: US 2014/0156423 A1
(43) Pub. Date: Jun. 5, 2014

(54) Suggesting Expired Product Replenishment Based On Receipt Data

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/691,040

(22) Filed: Nov. 30, 2012

(51) Int. Cl. G06Q 30/06; G06Q 20/20

(52) U.S. Cl. CPC G06Q 30/0631; G06Q 20/20
USPC 705/16

(57) ABSTRACT

A computer-implemented method is disclosed for suggesting purchases. Within the method, one or more point-of-sale transactions may be conducted. The transactions may involve a computer system and a customer possessing a mobile computing device. The computer system may store receipt data documenting the transactions. Sometime after the transactions, the computer system may search the receipt data in an effort to locate one or more products that have a high probability of having passed (or are very near) their expiration dates. When such products are identified, the corresponding customer may be so informed.

### BACKGROUND

1. Field of the Invention

This invention relates to point-of-sale systems and more particularly to systems and methods for analyzing electronic receipt data and suggesting product replenishment based thereon.

2. Background of the Invention

Many point-of-sale (POS) systems currently in use today do not support important emerging technologies, services, and marketing opportunities. For example, many POS systems are limited in their ability to collect and analyze electronic receipt data. As a result, those POS systems cannot effectively implement many novel methods and services surrounding such data. Accordingly, what is needed is an apparatus and method expanding the ability of a wide variety of POS systems and supporting computer systems, include legacy POS systems, to use electronic receipt data to benefit customers.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram illustrating an array of products that may have predictable expiration dates in accordance with the present invention;

FIG. 2 is a schematic block diagram of one embodiment of a point-of-sale (POS) system for implement methods in accordance with the present invention;

FIG. 3 is a schematic block diagram of one embodiment of multiple POS systems in accordance with the present invention operating in the context of an enterprise-wide system;

FIG. 4 is a schematic block diagram of one embodiment of a receipt in accordance with the present invention;

FIG. 5 is a schematic block diagram of one embodiment of a receipt module in accordance with the present invention;

FIG. 6 is a schematic block diagram of one embodiment of a suggestion module in accordance with the present invention;

FIG. 7 is a block diagram of one embodiment of a method for suggesting product replenishment in accordance with the present invention; and

FIG. 8 is a schematic block diagram of one embodiment of an exemplary image or sheet shot presented by a computing device to inform a customer of the expiration or pending expiration of one or more products and/or suggest the replenishment of one or more products that are expired or expiring in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

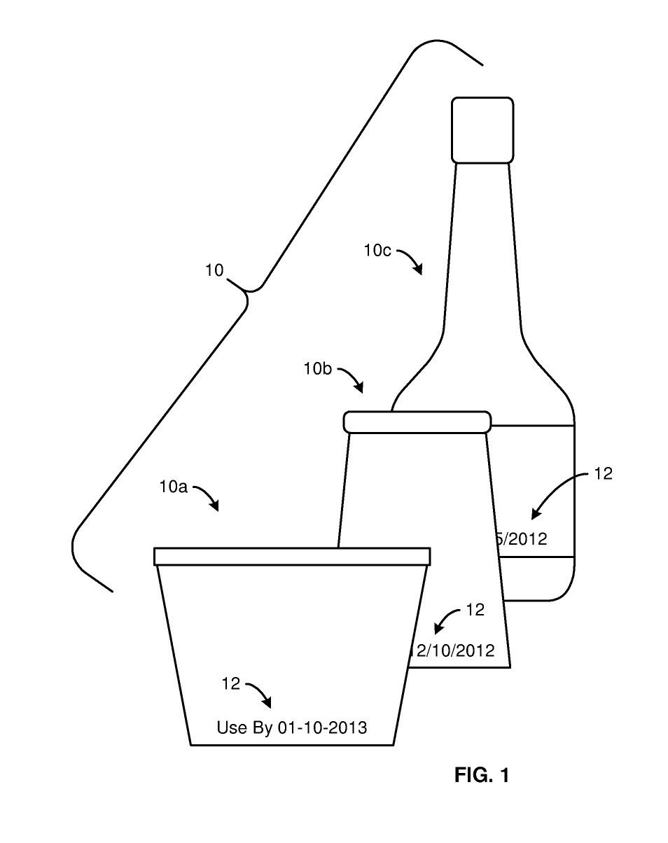

Referring to FIG. 1, in selected embodiments, a business, retailer, or the like may market one or more products that degrade over time. For example, a retailer may market food products, medicines, nutritional supplements, or the like that degrade (e.g., decompose, decrease in quality, decrease in potency, increase in risk of microbial contamination, or the like) with time. At some point, such products may pass from a generally acceptable condition to a generally unacceptable condition. This point in time may be described as the expiration of the product.

Some subset of the products that degrade over time may be products 10 having predictable expiration. Such products 10 may have inherent characteristics which make them likely to expire at some known interval after their purchase. For example, certain products 10 may correspond to an expiration date 12, “use by” date 12, “best by” date 12, or the like (hereinafter referred to as an “expiration date”). Often, an expiration date 12 may be printed on a product 10 or packaging corresponding thereto. In selected embodiments, this expiration date 12 may be relevant without regard to whether the packaging corresponding to the product 10 has been open, making it more predictable.

Alternatively, a “sell by” date may be printed on a product 10 or product packaging. While a sell by date is not the same as an expiration date 12, a sell by date may have a relatively fixed relationship with respect an expiration date 12. Accordingly, a sell by date may be used to calculate an expiration date 12.

Certain systems in accordance with the present invention may use expiration dates or related calculations to the benefit of one or more customers. For example, by simply knowing the date a certain product 10 was purchased by a customer, selected systems in accordance with the present invention may identify, with a high probability, when that product will expire. Accordingly, in certain embodiments, one or more computers, computers systems, mobile computing devices, or the like or a combination or sub-combination thereof may support, enable, or administer one or more suggestions for the replenishment of products that have expired or will do so shortly.

For example, according to the USDA, sour cream (opened or unopened) is good for up to three weeks after the “sell by” date. Accordingly, if it were determined that 90% of the sour cream sold by a retailer is purchased between five to ten days before a sell by date, then an expiration date 12 for the sour cream purchased at the retailer might fall twenty-six to thirty-one days after the purchase date. Alternatively, or in addition thereto, studies of stock levels may be used and add more data to a corresponding model. Thus, selected systems in accordance with the present invention may, in certain situations, determine a highly probable expiration date and benefit a customer by informing the customer when his or her sour cream has (or will shortly) expire.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

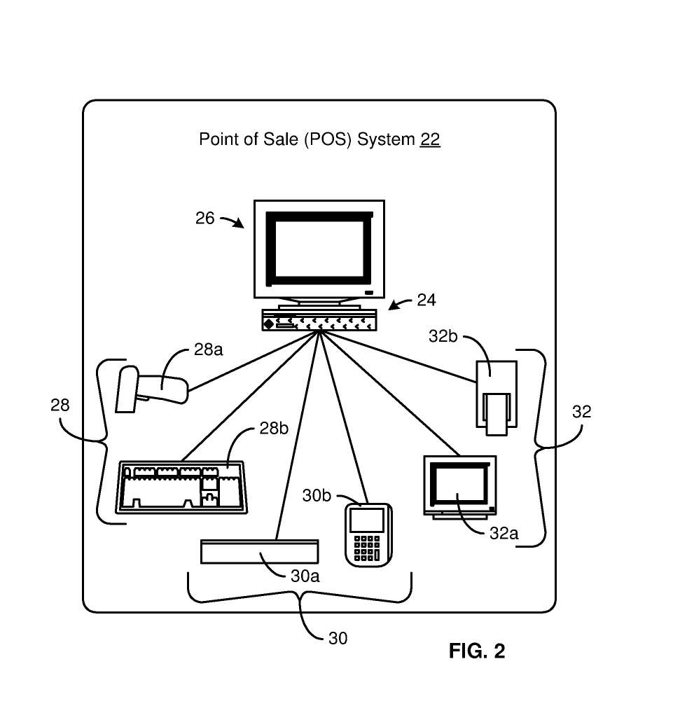

Referring to FIG. 2, in selected embodiments, the hardware, software, or hardware and software of a POS system 22 may be configured to implement one or more methods in accordance with the present invention. A POS system 22 in accordance with the present invention may include various components. In certain embodiments, a POS system 22 may include a central or primary computer 24, a monitor 26 (e.g., a cashier-facing monitor 26), one or more input devices 28 (e.g., scanners 28a, keyboards 28b, scales, or the like), one or more payment devices 30 (e.g., cash drawers 30a, card readers 30b) for receiving or returning payments, one or more output devices 32 (e.g., customer-facing display 32a or monitor 32a, receipt printer 32b), or the like or combinations or sub-combinations thereof.

A computer 24 may form the primary processing unit of a POS system 22. Other components 28, 30, 32 forming part of a POS system 22 may communicate with the computer 24. Input devices 28 and certain payment devices 30 may feed data and commands to a computer 24 for processing or implementation. For example, a scanner 28a may pass data communicating the identity of one or more items to be purchased, returned, or the like to a computer 24. Similarly, a card reader 30b may pass payment information to a computer 24.

Conversely, output devices 32 and certain payment devices 30 may follow or implement commands issued by a computer 24. For example, a cash drawer 30a may open in accordance with the commands of a computer 24. Similarly, a customer-facing display 32a and receipt printer 32b may display or output data or information as instructed by a computer 24.

In selected embodiments, in addition to handling consumer transactions (e.g., purchases, returns), a POS system 22 may also provide or support certain “back office” functionality. For example, a POS system 22 may provide or support inventory control, purchasing, receiving and transferring products, or the like. A POS system 22 may also store sales and customer information for reporting purposes, marketing purposes, receivables management, trend analysis, cost analysis, price analysis, profit analysis, or the like. If desired or necessary, a POS system 22 in accordance with the present invention may include an accounting interface to pass certain information to one or more in-house or independent accounting applications.

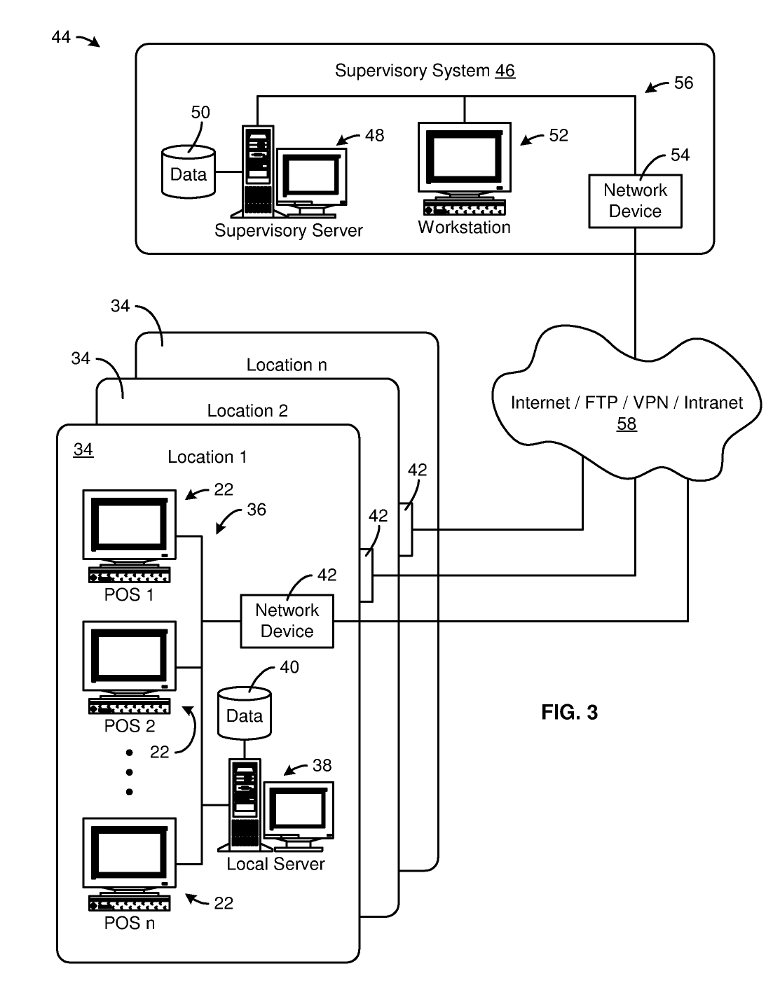

Referring to FIG. 3, in selected embodiments, a POS system 22 may operate substantially independently, as a stand-alone unit. Alternately, a POS system 22 in accordance with the present invention may be one of several POS systems 22 forming the front line of a larger system. For example, multiple POS systems 22 may operate at a particular location 34 (e.g., within a retail, brick-and-mortar store). In such embodiments, the various POS systems 22 may be interconnected via a LAN 36. A LAN 36 may also connect the POS systems 22 to a local server 38.

A local server 38 may support the operation of the associated POS systems 22. For example, a server 38 may provide a central repository from which certain data needed by the associated POS systems 22 may be stored, indexed, accessed, or the like. A server 38 may serve certain software to one or more POS systems 22. In certain embodiments, a POS system 22 may offload certain tasks, computations, verifications, or the like to a server 38.

Alternatively, or in addition thereto, a server 38 may support certain back office functionality. For example, a server 38 may receive and compile (e.g., within one or more associated databases 40) data from the various associated POS systems 22 to provide or support inventory control, purchasing, receiving and transferring products, or the like. A server 38 may also receive and compile sales and customer information for reporting purposes, marketing purposes, receivables management, trend analysis, cost analysis, price analysis, profit analysis, or the like.

In certain embodiments, one or more POS systems 22 or servers 38 corresponding to a particular location 34 may communicate with or access one or more remote computers or resources via one or more network devices 42. For example, a network device 42 may enable a POS system 22 to contact outside resources and verify the payment credentials (e.g., credit card information) provided by a customer. A network device 42 may comprise a modem, router, or the like.

In selected embodiments, a POS system 22 in accordance with the present invention may operate within an enterprise-wide system 44 comprising multiple locations 34 (e.g., branches 34 or stores 34). In such embodiments, each location 34 may have one or more POS systems 22, local servers 38, local databases 40, network devices 42, or the like or combinations or sub-combinations thereof connected by a computer network (e.g., a LAN 36). Additionally, each such location 34 may be configured to interact with one or more supervisory systems 46. For example, multiple branch locations 34 may report to an associated “headquarters” location or system.

A supervisory system 46 may comprise one or more supervisory servers 48, databases 50, workstations 52, network devices 54, or the like or combinations or sub-combinations thereof. The various components of a supervisory system 46 may be interconnected via a computer network (e.g., a LAN 56). In selected embodiments, a supervisory system 46 may comprise one or more supervisory servers 48 providing a central repository from which certain data needed by the one or more POS systems 22 or local servers 38 may be stored, indexed, accessed, or the like.

Alternatively, or in addition thereto, a supervisory server 48 may receive and compile (e.g., within one or more associated databases 50) data from the various associated POS systems 22 or local servers 38 to provide or support inventory control, purchasing, receiving and transferring products, or the like. A supervisory server 48 may also receive and compile sales and customer information for reporting purposes, marketing purposes, receivables management, trend analysis, cost analysis, price analysis, profit analysis, or the like.

A supervisory system 46 may be connected to one or more associated locations 34 or branches 34 in via any suitable computer network 58 (e.g., WAN 58). For example, in selected embodiments, one or more locations 34 may connect to a supervisor system 46 via the Internet. Communication over such a network 58 may follow any suitable protocol or security scheme. For example, communication may utilize the File Transfer Protocol (FTP), a virtual private network (VPN), intranet, or the like.

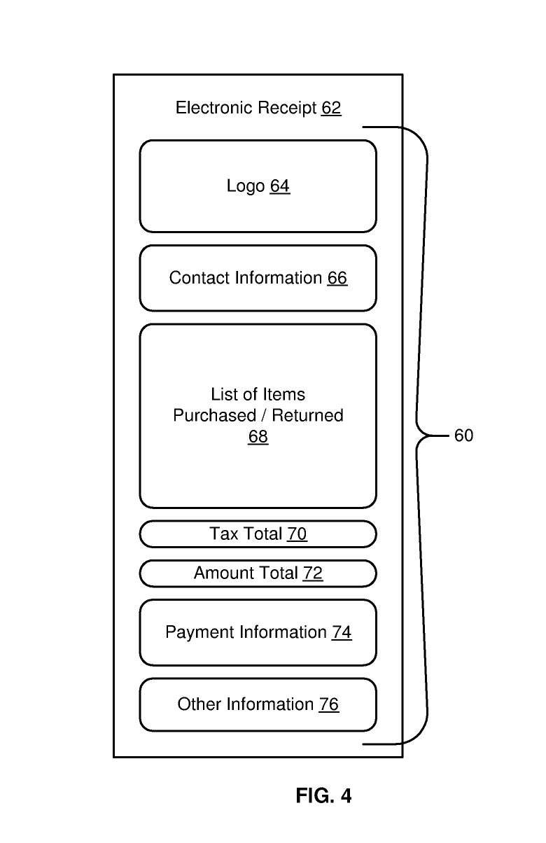

Referring to FIG. 4, a POS system 22 may collect and/or generate receipt data 60. Receipt data 60 may document a transaction (e.g., sale or return) carried out by a POS system 22. Receipt data 60 may be presented or displayed to a customer in the form of an electronic (e.g., paperless) receipt 62. In selected embodiments, receipt data 60 may be delivered to a customer's computing device (e.g., a mobile telephone, personal digital assistant (PDA), media player, tablet computer or reader, laptop computer, desktop computer, or the like, hereinafter a “computing device”) by an entity's computer system (e.g., a system comprising one or more POS systems 22, local servers 38, supervisory servers 48, some other onsite resources, one or more applications running on a customer's computing device, some other offsite resources, or the like or combinations or sub-combinations thereof, hereinafter a “computer system”).

In selected embodiments, receipt data 60 and an electronic receipt 62 may include a logo 64, contact information 66, a list 68 of items purchased or returned, a total 70 indicating the sales tax assessed or returned, a total 72 indicating the amount paid or returned, payment information 74, other information 76, or the like or combinations or sub-combinations thereof.

A logo 64 may reinforce the brand and image of the associated entity within the mind of a consumer. By including contact information 66 on an electronic receipt 62, an entity may ensure that a customer has ready access to one or more physical addresses, Internet address, telephone numbers, facsimile numbers, hours of operation, or the like or combinations or sub-combinations thereof. One or more of a list 68 of items purchased or returned, a total 70 indicating the sales tax assessed or returned, a total 72 indicating the amount paid or returned, and payment information 74 (e.g., date of transaction, an indication of method of payment, an indication of which credit or debit card was used, etc.) may be included to document important details of a transaction.

Other information 76 may be included within an electronic receipt 62 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

An electronic receipt 62 may be presented by a computing device of a customer in any suitable layout or format. For example, the receipt data 60 forming an electronic receipt 62 may simply be presented as a textual list. Alternatively, an electronic receipt 62 may follow the form of a paper receipt. That is, the electronic receipt 62 may comprise a virtual representation or layout substantially matching what a comparable paper receipt would look like.

The manner in which an electronic receipt 62 is presented or displayed on a computing device of a customer may be completely dictated by the computer system delivering the receipt data 60 thereto. Alternatively, the computing device of the customer may have an application (e.g., a receipt manager, accounting program, budgeting program, or the like) installed thereon. Such an application may partially or completely control the layout or format of an electronic receipt 62 displayed therewith or therethrough. For example, a computer system may supply receipt data 60, while the application installed on the computing device of the customer supplies the layout or formatting.

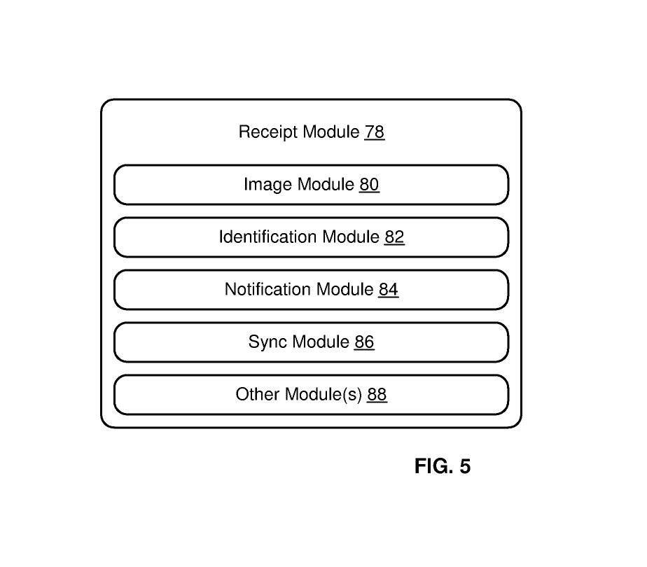

Referring to FIG. 5, a computer system in accordance with the present invention may deliver receipt data 60 to a computing device of a customer in any suitable manner. In selected embodiments, a receipt module 78 may enable or support such delivery. A receipt module 78 may include any suitable arrangement of sub-components or modules. In certain embodiments, a receipt module 78 may include an image module 80, identification module 82, notification module 84, synchronization module 86, one or more other modules 88 as desired or necessary, or the like or some combination or sub-combination thereof.

An image module 80 may assemble, generate, or obtain an advertisement comprising a call to action. A call to action may invite or motivate a customer to take a particular step or action. For example, a call to action may invite or motive a consumer to download receipt data 60. To increase the likelihood that a consumer will respond favorably to the call to action, an advertisement may include an enabler facilitating the desired step or action. For example, in selected embodiments, an advertisement may include a machine-readable code. By scanning the code (e.g., scanning the code using a camera on a mobile telephone, tablet computer, or the like), a consumer may import receipt data 60 encoded within the code. Alternatively, scanning the code may initiate the download of receipt data 60.

For example, a machine-readable code may be encoded with a URL. In addition to designating a particular resource, a URL may also include a transaction identification (ID). Accordingly, after an appropriate application is launched and a machine-readable code is scanned, a URL may be passed from a customer (e.g., from a mobile telephone of a customer) to an Internet Service Provider (e.g., a telecommunications provider). As a result, an appropriate resource within a computer system may be accessed and receipt data may be returned to (e.g., downloaded by) a computing device.

In selected embodiments, a machine-readable code may comprise a barcode. For example, in certain embodiments, a machine-readable code may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

An identification module 82 may be tasked with requesting, collecting, and/or communicating identification information linking a customer associated with a transaction with one or more records stored within a computer system. For example, as part of a transaction carried out at a POS system 22, an identification module 82 may request, collect, and/or communicate identification information linking a transaction to a particular computing device or account corresponding to the customer participating in the transaction. Thus, information corresponding to the transaction may be passed to the customer via the particular computing device or account.

An identification module 82 may request, collect, and/or communicate one or more types of identification information. For example, in selected embodiments, an identification module 82 may collect a unique identification or membership number from a customer. This may be done when a membership card, club card, loyalty card, identification card, credit card, debit card, fingerprint or other biometric characteristic, or the like is scanned, input, or otherwise collected at a POS system 22. In other situations, a cashier or customer may type in a unique identification number, payment number, membership number, or the like at a POS system 22. For example, while a cashier is processing a transaction, a customer may be prompted via a card reader 30b, customer-facing display 32a, or the like to enter (e.g., type in using the card reader 30b) a mobile telephone number corresponding to the customer. Alternatively, a cashier may type in a telephone number corresponding to the customer.

Once the identification information is received, it may be used directly (e.g., used directly to pass receipt data 60 to a computing device of a corresponding customer). Alternatively, or in addition thereto, the identification information may tie or link a current transaction to one or more previously stored computer records. For example, within such records, a computer system may find the information necessary to identify and communicate with a computing device or account of a corresponding customer. Alternatively, or in addition thereto, such records may enable a computer system to tie or link a current transaction to an appropriate computing device or account.

A notification module 84 may assemble, generate, obtain, direct, and/or issue one or more push notifications. In selected embodiments, push notifications may be directed to a computing device of a customer. For example, when an appropriate application in not running on a computing device, push notifications may inform the customer that certain data or options are available (e.g., that a new electronic receipt 62 is available for download).

A synchronization module 86 may support or enable one way or two way data communication between a computer system and a computing device. For example, a synchronization module 86 may support or enable the passing of receipt data 60 from a computer system to a computing device. A synchronization module 86 may also enable certain data received from a computing device to be incorporated within or used by a computer system. For example, one or more user preferences (e.g., notification preferences) may be communicated to a computer system from an application resident on a computing device.

The various functions or modules of a receipt module 78 may be enacted or implemented by any suitable system or component thereof. For example, in selected embodiments, one or more functions or modules of a receipt module 78 may be distributed across one or more hardware devices, including a primary computer 24 of a POS system 22, a local server 38, a supervisory server 48, some other onsite resource, a computing device, some other offsite resource, or the like or combinations or sub-combinations thereof. Thus, systems and methods in accordance with the present invention may be adapted to a wide variety of situations, including more rigid legacy systems.

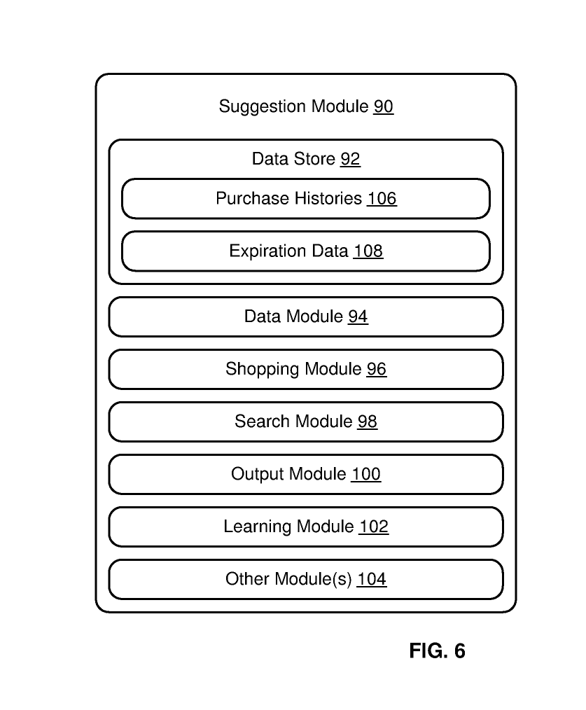

Referring to FIG. 6, in selected embodiments, one or more computers, computers systems, mobile computing devices, or the like or a combination or sub-combination thereof may support or enable a suggestion module 90. A suggestion module 90 may use certain receipt data 60 to inform an appropriate customer of the expiration or pending expiration of one or more products 10 and/or to suggest replenishment of the expired or expiring products 10. A suggestion module 90 may include any suitable arrangement of sub-components or modules. In certain embodiments, a reminder module 90 may include a data store 92, data module 94, shopping module 96, search module 98, output module 100, learning module 102, one or more other modules 104 as desired or necessary, or the like or a combination or sub-combination thereof.

A data store 92 may contain records supporting the operation of a suggestion module 90. In selected embodiments, a data store 92 may contain or store one or more purchase histories 106. A purchase history 106 may comprise one or more records linking a particular customer to one or more products purchased by the customer. A purchase history 106 may also comprise one or more records identifying when one or more products were purchased.

A data store 92 may also contain expiration data 108 linking one or more products 10 having predictable expiration with the expiration information corresponding thereto. In certain embodiments, expiration data 108 may include the numbers (e.g., numbers characterizing one or more periods of time, numbers characterizing one or more stock levels, one or more means or averages, one or more medians, or the like) necessary to convert a purchase date into an expected expiration date 12 or range.

For example, it may be determined that a product 10 expires a first period of time after it is made, packaged, or the like. It may be further determined that a second, lesser period of time typically passes before a product 10 is purchased. Thus, expiration data 108 may comprise the first period, the second period, or some combination thereof (e.g., a difference between the first period and the second period).

A data store 92 may contain records for any suitable arrangement or combination of products 10. In selected embodiments, expiration data 108 may comprise expiration information (e.g., numbers, dates, periods of time, or the like) for all products 10 of predictable expiration sold by a particular retailer. Alternatively, expiration data 108 may comprise expiration information for only a subset of all products 10 of predictable expiration sold by a particular retailer. For example, expiration data 108 may comprise expiration information only for products 10 whose purchase expiration falls within ranges of time, predictability, or the like (e.g., products 10 whose expiration is greater than two weeks and less than or equal to two months, products 10 whose expiration is greater than one month and less than or equal to two years, etc.).

A data store 92 may identify products 10 in any suitable method. For example, in selected embodiments, a data store 92 may identify products using Universal Product Codes (UPCs), retailer-specific identification codes, or the like. Accordingly, systems in accordance with the present invention and the modules corresponding thereto may accurately communicate, store, compare, and the like information corresponding to such products 10.

A data module 94 may perform certain processing or preprocessing functions with respect to selected contents of a data store 92. For example, in selected embodiments, a data module 94 may calculate one or more expiration dates 12 using information contained within a data store 92. A data module 94 may calculate such expiration dates 12 on demand as needed. Alternatively, a data module 94 may calculate one or more expiration dates 12 and link such dates to corresponding products 10 within a data store 92. Accordingly, a data store 92 may store expiration dates 12 for certain products 10 identified within one or more product histories 106.

For example, expiration data 108 may indicate that a particular product 10 expires a first period of time after it is made, packaged, or the like. Expiration data 108 may further indicate that a second, lesser period of time typically passes before the product 10 is purchased. Thus, a data module 94 may calculate the expiration date 12 for a particular instance of the product 10 as the date of purchase corresponding thereto plus the first period of time, minus the second period of time. The resulting expiration date 12 may then be linked within a data store 92 to the particular instance of the product 10. Additionally, in selected embodiments, studies of stock levels may be used by a data module 94 and add more data to a corresponding model for calculating one or more expiration dates 12.

A shopping module 96 may support a customer in creating, modifying, and/or using a shopping list. In certain embodiments, a shopping module 96 may enable a suggestion module 90 to gather insights into future purchases of a customer. Accordingly, in selected embodiments, a shopping module 96 may assist a suggestion module 90 in determining when to search for expired or expiring products 10 and/or which suggestions corresponding to expired or expiring products 10 are likely to be most helpful or useful for one or more corresponding customers.

A search module 98 may be programmed to search receipt data 60 (e.g., one or more purchase histories 106), expiration data 108, a shopping list, or the like or a combination thereof. Accordingly, in selected embodiments, for any given time, a search module 98 may identify one or more products 10 whose expiration or approaching expiration may be brought to the attention of one or more corresponding customers.

An output module 100 may support or enable the generating, passing, storing, implementing, and/or issuing of one or more suggestions or queries corresponding thereto. In certain embodiments, when a search module 98 determines that a particular product 10 has expired (or will do so shortly), an associated output module 100 may so inform a corresponding customer. Additionally, an output module 100 may query whether the customer would like to add the particular product to a shopping list or the like.

For example, an output module 100 may issue a query stating “We noticed that the sour cream you purchased last month has likely expired. Would you like us to add sour cream to your shopping list?” If the customer responds in the affirmative, an output module 100 may cooperate with a shopping module 96 to create or modify a shopping list corresponding to the customer.

A learning module 102 may enable a suggestion module 90 to improve its function or performance over time. That is, a suggestion module 90 may be aimed at generating a positive experience for the customer. A primary benefit to an entity supporting a suggestion module 90 (e.g., a retailer) may be increased customer loyalty, not increased sales due to suggestions made. Accordingly, a learning module 102 may assist a suggestion module 90 in striking a proper balance between being helpful and being overly demanding of the attentions of the customer.

For example, in selected embodiments, a learning module 102 may monitor selected interactions with a particular customer and/or a group of customers in an effort to identify which suggestions or other interactions are most helpful. This may be accomplished by analyzing the characteristics of suggestions that are accepted. For example, if queries as to whether selected products should be added to corresponding shopping lists are regularly answered in the affirmative, the activity may be view as helpful. Conversely, if queries as to whether certain other products should be added to corresponding shopping lists are regularly answered in the negative, the activity may be view as unhelpful. Helpful suggestions or interactions may be continued or expanded for a particular customer or a group of customers, while less helpful or unhelpful suggestions or interactions may be avoided or eliminated for a corresponding customer or a group of customers.

The various functions or modules of a suggestion module 90 may be enacted or implemented by any suitable system or component thereof. For example, in selected embodiments, one or more functions or modules of a suggestion module 90 may be distributed across one or more hardware devices, including a primary computer 24 of a POS system 22, a local server 38, a supervisory server 48, some other onsite resource, a computing device, some other offsite resource, or the like or combinations or sub-combinations thereof. Thus, systems and methods in accordance with the present invention may be adapted to a wide variety of situations, including more rigid legacy systems.

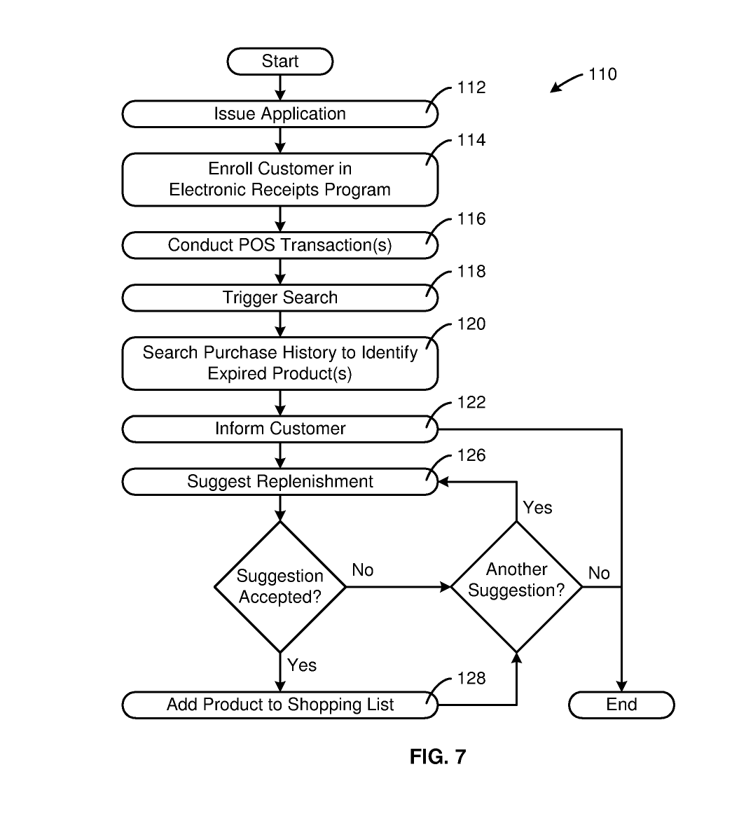

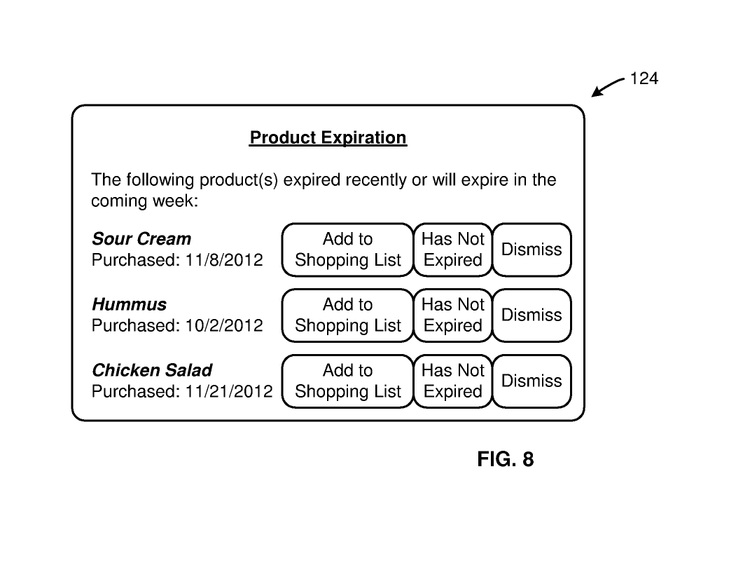

Referring to FIGS. 7 and 8, one method 110 in accordance with the present invention may begin when an appropriate application (e.g., a retailer's mobile application, an electronic receipts application, or the like or a combination or sub-combination thereof) is issued 112 and installed on a computing device of a customer. A computer system may then enroll 114 the customer in an electronic receipts program. In selected embodiments, this enrollment 114 may result in the computing device (or an application installed thereon) being linked to or associated with certain identification information within the records of a computer system.

In other embodiments, the enrollment 114 may be independent of any specific computing device. For example, in selected embodiments, enrollment 114 may comprise the generation of an account. The customer may then access the account (e.g., “log into” the account) using a computing device. Accordingly, a customer may access the account via any one of several computing devices. Moreover, by “logging out” of an account, the corresponding computing device may be separated from the account.

In an enrollment 114 process or sometime thereafter, a customer may communicate selected preferences or fix certain settings. In selected embodiments, such preferences or settings may correspond to suggestions and/or product-expiration reports in accordance with the present invention. For example, via selected preferences or certain settings, a customer may opt in or out of receiving suggestions and/or product-expiration reports.

So prepared, a customer may, on one or more occasions, enter a “brick-and-mortar” business location (e.g., enter a brick-and-mortar retail store with his or her computing device), select one or more items for purchase, and approach a POS system 22. At one or more POS systems 22, one or more transactions (e.g., one or more purchases) may be initiated and completed 116.

During each such transaction, a computer system may receive identification information. For example, a POS system 22 may scan a membership card, club card, loyalty card, identification card, credit card, debit card, or the like. From the scan, identification information (e.g., a unique identification number, membership number, or the like) may be obtained. Alternatively, while a cashier is processing a transaction, a customer may be prompted via a card reader 32b, customer-facing display 32a, or the like to enter (e.g., type in using the card reader 32b) an identification number (e.g., a mobile telephone number).

Identification information may be passed from a POS system 22 to one or more other computers (e.g., servers 38, 48) within a computer system. The identification information may link a customer and a corresponding transaction to one or more records stored within a computer system. In selected embodiments, such records may contain the information necessary to identify and communicate with a computing device or account of the corresponding customer. Accordingly, a computer system may deliver receipt data 60 documenting the transaction to an appropriate computing device or account. Additionally, such identification may enable one or more purchase histories 106 (e.g., compilations of receipt data 60 from one or more receipts 62) to be created.

At some point thereafter, a search for expired or expiring products 10 may be triggered 118. A search may be triggered 118 in any suitable manner. In selected embodiments, a search may be triggered 118 by a customer. For example, via a computing device, a customer may issue a command (e.g., select a corresponding button) for an application to display certain expired or expiring products 10 (e.g., product 10 that has expired or will expired in a particular period of time). Alternatively, a search may be triggered 118 by some other action of a customer.

For example, in selected embodiments, a search may be triggered 118 when a customer uses a corresponding computing device to initiate, modify, and/or save a shopping list. Such actions may indicate that the customer is planning future shopping activity. Accordingly, it may be an appropriate time to search 120 one or more purchase histories 106, bring 122 one or more expirations to the attention of the customer, and enable the customer to timely take whatever action is needed.

Searching 120 one or more purchase histories 106 for expired or expiring product 10 may be conducted in any suitable manner. In selected embodiments, searching 120 may comprise submitting a query to a data store 92. Such a query may seek a listing of all products 10 having an expiration date 12 falling within a particular window. This window may be fixed or variable. For example, in certain embodiments, the window may cover a fixed period of time (e.g., all products 10 having an expiration date falling within a window beginning two weeks in the past and ending one week in the future). Alternatively, the window may cover a variable period of time (e.g., all products 10 having an expiration date falling within a window beginning at the last shopping trip and ending one week in the future).

In addition to querying, searching 120 may include certain processing, analysis, and/or calculations. In selected embodiments, searching 120 may include calculating (e.g., by a data module 94) one or more expiration dates 12. Alternatively, or in addition thereto, searching 120 may include filtering search results. For example, searching 120 may include filtering to remove any products 10 listed in a current or active shopping list. That is, if a sour cream product 10 has expired and would normally be brought 122 to the attention of a customer, but is already listed on a current or active shopping list, then the sour cream product 10 may be filtered out as unnecessary.

Searching 120 may provide an opportunity to apply the learning compiled by a learning module 102. For example, during searching 120, one or more products 10 deemed to be unhelpful (e.g., unhelpful for customers individually and/or collectively) may be filtered out. This may ensure that only information, suggestions, or the like that are helpful are passed on to customers. Moreover, it may ensure than a customer is not overwhelmed with information, suggestions, or the like. For example, a learning module 102 may observe that presenting three or less suggestions or product-expiration reports is ideal. Accordingly, search results may be filtered such that the suggestions or product-expiration reports are appropriately capped and only those deemed to be most helpful are displayed or passed to corresponding customers.

A customer may be informed 122 that one or more products 10 are expired or expiring in any suitable manner. For example, in selected embodiments, an image 124, message, or notification (e.g., local notification, push notification) presented via a computing device may simply communicate 122 that one or more products 10 have expired and/or will shortly expire. Such communication may occur simultaneously or serially. That is, if the expiration or pending expiration of more than one product 10 is to be communicated 122, it may be communicated 122 for the multiple products 10 simultaneously via a single image 124, message, or the like or, alternatively, via a serious of images 124, messages, etc.

In selected embodiments, situations, or applications, a method 110 may be focused on simply informing 122 a customer of the expiration or pending expiration of one or more products 10. This may be considered a very soft, implicit suggestion to replenish or replace the expired or expiring product 10. Accordingly, in selected embodiments, after a customer is informed 122 of the expiration or pending expiration, a method 110 may end. Alternatively, a method 110 may be focused on assisting a customer to some extent greater than simply informing 122 a customer of the expiration or pending expiration of one or more products 10.

For example, in certain embodiments, a method 110 may include explicitly suggesting 126 replenishment of the expired or expiring product 10. Explicitly suggesting 126 replenishment may be accomplished in any suitable manner. In selected embodiments, a computer system may suggest 126 replenishment by inquiring whether the customer would like to add the expired or expiring product 10 to a shopping list.

If such an inquiry reveals that no addition to a shopping list is desired, and no more inquiries for other products 10 are needed or are to be made, then a method 110 may end. Conversely, if an inquiry reveals that no addition to a shopping list is desired, and another suggestion (e.g., inquiry) corresponding to another product 10 is needed or desired, then a method 110 may continue with an inquiry whether the customer would like to add the next expired or expiring product 10 to a shopping list. Whenever a customer desires to add a particular product 10 to a shopping list (e.g., whenever the response to an inquiry is in the affirmative), then a method 110 may continue with the adding 128 of the product 10 to an appropriate shopping list.

Suggestions to replenish product 10 may be made to a customer in any suitable manner. For example, in selected embodiments, an image 124, message, or notification (e.g., local notification, push notification) presented via a computing device may simply inquire whether one or more products 10 should be added to a shopping list. Such communication may occur simultaneously or serially. That is, if the replenishment of more than one product 10 is to be suggested 126, it may be suggested 126 for multiple products 10 simultaneously via a single image 124, message, or the like or, alternatively, via a serious of images 124, messages, etc.

In selected embodiments, the informing 122 of the expiration or pending expiration of one or more products 10 and the explicitly suggesting 126 replenishment of the expired or expiring product 10 may occur at separate times. Alternatively, they may occur substantially simultaneously. For example, an image 124 presented via a computing device may communicate 122 that one or more products 10 have expired and/or will shortly expire and simultaneously offer to add the one or more products 10 to a shopping list. In certain embodiments, this may be accomplished by listing each expired or expiring product 10 in association with an option (e.g., a button) to add the product 10 to a shopping list, indicate the product 10 has not yet expired, dismiss the product 10, or some combination thereof.

The flowchart in FIG. 7 illustrates the architecture, functionality, and operation of possible implementations of systems, methods, and computer program products according to certain embodiments of the present invention. In this regard, each block in the flowchart may represent a module, segment, or portion of code, which comprises one or more executable instructions for implementing the specified logical function(s). It will also be noted that each block of the flowchart illustration, and combinations of blocks in the flowchart illustration, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A computer-implemented method for suggesting purchases, the method comprising:
storing, by a computer system, one or more records correlating expiration data to one or more products having predictable expiration;
conducting, by a point-of-sale system forming part of the computer system, a point-of-sale transaction involving a customer possessing a computing device;
determining, by the computer system using the one or more records, that a first product identified within receipt data documenting the point-of-sale transaction has passed an expected expiration date; and
informing, by the computer system via the computing device, the customer that the first product has expired.

2. The method of claim 1, wherein the point-of-sale system is contained within a brick-and-mortar store corresponding to a retailer.

3. The method of claim 2, wherein the conducting comprises receiving the customer within the brick-and-mortar store.

4. The method of claim 3, wherein the conducting further comprises delivering the receipt data to an application installed on the computing device in the form of an electronic receipt.

5. The method of claim 4, wherein the application comprises part of the computer system.

6. The method of claim 5, further comprising initiating, by the application, a shopping list.

7. The method of claim 6, wherein the initiating precedes the determining.

8. The method of claim 7, wherein the determining comprises searching, by the computer system, the receipt data in an effort to identify certain products listed therein that have passed an expected expiration date at the time of the searching.

9. The method of claim 8, wherein the initiating triggers the searching.

10. The method of claim 9, receiving, by the application from the customer after the informing, an instruction to add the first product to the shopping list.

11. A computer-implemented method for suggesting purchases, the method comprising:
storing, by a computer system, one or more records correlating expiration data to one or more food products having predictable expiration;
conducting, by a point-of-sale system forming part of the computer system, a point-of-sale transaction involving a customer possessing a mobile computing device;
delivering, by the computer system to the mobile computing device, receipt data documenting the point-of-sale transaction;
determining, by the computer system using the one or more records, that a first product identified within receipt data has passed an expected expiration date; and
informing, by the computer system via the mobile computing device, the customer that the first product has expired.

12. The method of claim 11, wherein the delivering comprises delivering the receipt data to an application installed on the mobile computing device in the form of an electronic receipt.

13. The method of claim 12, wherein the application comprises part of the computer system.

14. The method of claim 13, further comprising initiating, by the application at the instruction of the customer, a shopping list.

15. The method of claim 14, wherein the initiating precedes the determining.

16. The method of claim 15, wherein the determining comprises searching, by the computer system, the receipt data in an effort to identify certain products listed therein that have passed an expected expiration date at the time of the searching.

17. The method of claim 16, wherein the initiating triggers the searching.

18. The method of claim 17, receiving, by the application from the customer after the informing, an instruction to add the first product to the shopping list.

19. The method of claim 18, wherein:
the point-of-sale system is contained within a brick-and-mortar store corresponding to a retailer; and
the conducting comprises receiving the customer within the brick-and-mortar store.

20. A computer system comprising:
one or more processors;
one or more memory devices operably connected to the one or more processors; and
the one or more memory devices collectively storing
a receipt module programmed to deliver receipt data documenting one or more point-of-sale transactions to one or more computing devices of corresponding customers,
a data store storing one or more records correlating expiration data to one or more products having predictable expiration,
a search module programmed to identify products that form part of the one or more point-of-sale transactions and that, according to the one or more records, have passed an expected expiration date, and
an output module programmed to inform appropriate customers that one or more products corresponding thereto have passed an expected expiration date.
